(19) United States
(12) Patent Application Publication
(10) Pub. No.: US 2019/0009443 A1
(43) Pub. Date: Jan. 10, 2019

(54) INJECTION MOLDING DEVICE FOR MANUFACTURING TUBES HAVING AN UNDERCUT INTERNAL GEOMETRY, PREFERABLY AN INTERNAL THREAD, AND METHOD FOR MANUFACTURING TUBES OF SAID TYPE

(71) Applicant: KAUTEX TEXTRON GMBH & CO. KG, Bonn (DE)

(72) Inventor: Hartmut WOLF, Koenigswinter (DE)

(21) Appl. No.: 16/063,006

(22) PCT Filed: Dec. 6, 2016
(86) PCT No.: PCT/EP2016/079931

§ 371 Date: Jun. 15, 2018

(30) Foreign Application Priority Data
Dec. 15, 2015 (DE) 10 2015 225 247.7

(51) Int. Cl. B29C 45/44; B29C 45/26; B29C 45/17

(52) U.S. Cl. CPC B29C 45/44; B29C 45/2612; B29C 2045/0087; B29C 45/1704; B29C 2045/445; B29C 45/262

(57) ABSTRACT

The invention relates to an injection molding device for manufacturing tubes having an internal thread, having a tool that forms an article cavity, having means for filling the article cavity with a thermoplastic molding compound, having an injection device for injecting a fluid toward a projectile to be driven through the article cavity, wherein the injection device comprises a projectile carrier having at least one injection nozzle and having at least one projectile receptacle for a projectile as a displacement member for the molding compound, wherein the projectile carrier at an end that is remote from the projectile receptacle is provided with a thread-bearing stamping core which is adjustable relative to the projectile carrier between a thread-forming first position and a demolded second position, wherein the stamping core in the thread-forming position plunges into the article cavity and seals the latter.

### FIELD

The invention relates to an injection molding device for manufacturing tubes having an undercut internal geometry, preferably having an internal thread. The invention furthermore relates to a method for manufacturing tubes with an internal thread by injection molding a thermoplastic molding compound by means of an injection molding device, preferably using the aforementioned injection molding device.

### BACKGROUND

Various methods for producing tubes from thermoplastic plastics material are known in the prior art. Such tubes can be produced, for example, by suction blow-molding or by injection molding. Tubes which are curved in various spatial axes, so-called 3D tubes, are often produced by suction blow-molding. A tubular preform is extruded herein and pulled into a corresponding blow-molding tool. Extrusion methods in which tubular preforms are placed into an opened tool are also known, wherein the final molding of the preforms within the tool is performed by applying a pressure differential and wherein the tool molds the external contour of the tube.

Injection molding methods using injection-molding tools with encircling molding tunnels are known for the production of corrugated tubes or ribbed tubes which extend in a substantially linear manner.

It is moreover known for tubes to be fabricated by injection molding by means of so-called projectile injection technology. In this method, a projectile that is placed onto an injector is driven through the article cavity of the filled tool, wherein the molten core of the thermoplastic plastics material is displaced into a secondary cavity which after the preliminary filling with polymer is released by way of hydraulically activated slides. Such tubes have a defined internal diameter and having such a defined, constant internal diameter can be produced in a comparatively reproducible manner.

In particular, the production of tubes to be installed as ventilation pipes for air-conditioning systems or as filler pipes for fuel containers, wiper water containers, or urea containers in motor vehicles, or tubes as parts of the supply of combustion air in the case of internal combustion engines for motor vehicles are produced by the methods described above. Such tubes are to be provided with widened connector sleeves, threaded connectors, and branching points which, on account of the production methods mentioned above, are comparatively difficult to mold thereon. For example, injection-molded tubes which were produced with the water injection technology or the projectile injection technology do not have any integrated threads, in particular any internal threads, nor any defined lateral connectors having a large connector cross section for further functional parts. On account of the split tool it is also comparatively difficult for respective sealing geometries to be provided at the connector ends of the tubes.

In the case of extrusion blow-molded tubes it is therefore known for the ends to be calibrated in the manufacturing procedure of the tubes. Sealing geometries and threads are usually implemented by metallic thread attachments or by welded-on injection molded components. In order for components to be laterally connected to the tubes, said components are usually welded on in the region of removed circular openings.

Manufacturing tubes of this type, having branches, threaded portions and sleeve portions or plug-fitting ends, is therefore comparatively complex. In particular, the manufacturing of internal threads in the prior art can only be accomplished by insert-molding components that have been separately manufactured.

### SUMMARY

The invention is therefore based on the object of providing an injection molding device mentioned at the outset, for manufacturing tubes having an undercut internal geometry, preferably having an internal thread.

The invention is furthermore based on the object of providing a method for manufacturing tubes having an undercut internal geometry, preferably having an internal thread, by injection molding a thermoplastic molding compound.

One aspect of the invention relates to an injection molding device for manufacturing tubes having an undercut internal geometry, preferably having an internal thread, having a tool that forms an article cavity, having means for filling the article cavity with a thermoplastic molding compound, having an injection device for injecting a fluid toward a projectile that is to be driven through the article cavity, wherein the injection device comprises a projectile carrier having at least one injection nozzle and having at least one projectile receptacle for a projectile as a displacement member for the molding compound, wherein the projectile carrier at an end that is remote from the projectile receptacle is provided with a profiled or thread-bearing stamping core which is adjustable relative to the projectile carrier between a thread-forming first position, and a demolded second position, wherein the stamping core in the thread-forming position plunges into the article cavity and seals the latter.

The stamping core can be configured, for example, so as to be conical and in a translatory manner so as to be adjustable relative to the projectile carrier such that an undercut profile in the interior of the tube is capable of being generated by said stamping core by way of an adjusting movement in the longitudinal axis of the projectile carrier.

The injection device preferably comprises a projectile carrier which at an end that is remote from the projectile receptacle is provided with a thread-bearing rotary core as the stamping core in the context of the invention. In a thread-forming first position of the projectile carrier, in which the latter extends within the article cavity, the thread-bearing rotary core conjointly with the tool forms an annular space in the article cavity, said annular space when filled with a molding compound, imparting an internal thread of the tube. The thread-bearing rotary core, for example on the external face thereof, can be provided with a respective ribbed pattern which forms one or a plurality of continuous thread turns. Pulling the rotary core, or demolding the rotary core, respectively, is expediently performed in that the rotary core is applied a rotating movement by way of a respective mechanism. The rotary core is preferably both rotatable as well as adjustable in a translatory manner in the direction of the longitudinal extent of the article cavity.

An internal thread of the article that is to be manufactured as a tube can be manufactured in this way with the rotary core, said internal thread being configured so as to be substantially without disruption, that is to say without any mold separation seams or the like. The stamping core can be configured so as to be both cylindrical as well as conical.

The injection molding device according to the invention expediently comprises a secondary cavity which receives the molding compound that is displaced by the projectile. Those parts of the injection molding device which form the article cavity are referred to as a tool in the context of the present patent application. The tool in the context of the invention can have further movable mold parts such as slides, movable mold cores, and the like. The article cavity of the tool is expediently connected to a secondary cavity which receives the molding compound that is displaced by the projectile.

The injection device according to the invention is configured to inject a highly pressurized fluid, for example to inject water, into the article cavity, wherein the projectile carrier of the injection device can be penetrated by one or a plurality of fluid ducts and at the end of said projectile carrier that is configured for receiving the projectile configures an injection nozzle. In this way, the projectile can be driven through the article cavity by means of the fluid. The molten core of the molding compound that is received by the article cavity herein is displaced into the secondary cavity. The secondary cavity by means of hydraulically activatable slides can initially be separated from the article cavity. Upon partial or complete filling of the article cavity with the molding compound, the secondary cavity can be released by means of the slides such that the molding compound that has been displaced by way of the projectile can enter the secondary cavity.

Any arbitrary thermoplastic polymer can be provided as the thermoplastic molding compound in the context of the invention. For example, a thermoplastic plastics material which is selected from a group comprising high-density polyethylene, polyamide, polyamide 6, polyamide 12, polyurethane, polycarbonate, acrylonitrile-butadiene-styrene-copolymer, polyketone, polystyrene, olefin-based thermoplastic elastomers, olefin-based cross-linked thermoplastic elastomers, urethane-based thermoplastic elastomers, thermoplastic polyester elastomers, and thermoplastic copolymers can be provided as the thermoplastic molding compound.

The injection molding device according to the invention can comprise at least one sprue which opens into the article cavity.

In the case of one preferred variant of the injection molding device it can be provided that the projectile carrier is configured as a multiple-part first mold core having a threadless shank and having a receptacle for the stamping core. The projectile carrier per se preferably configures a mold core which conjointly with the tool forms an annular space in part of the article cavity for molding a calibrated portion of the tube.

A shank portion of the projectile carrier on which the stamping core is disposed so as to be axially adjustable can be provided as the receptacle for the stamping core, for example.

The stamping core can be adjustable between the first and the second position by means of a spindle drive provided to this end.

The threadless shank of the projectile carrier expediently has an external diameter which approximately corresponds to the internal diameter of the tube to be molded as the article.

The projectile carrier at the leading end thereof is expediently provided with a projectile receptacle for the projectile, wherein the projectile receptacle can be configured, for example, as a diameter step of the shank of the projectile carrier, said diameter step being dimensioned such that the projectile bears on an encircling shoulder of the shank such that the shell area of said projectile terminates so as to be flush with the threadless shank of the projectile carrier.

The stamping core can have an external diameter which is larger than the threadless portion of the shank, for example, such that a portion of the tube that is widened in the manner of a sleeve is capable of being molded by way of said stamping core.

In the case of one preferred and expedient variant of the injection molding device according to the invention it is provided that the receptacle for the stamping core is configured as a guide spindle for the stamping core, the latter having a spindle drive that is complementary to said guide spindle.

One expedient variant of the injection molding device according to the invention is distinguished by at least one second mold core which in a first position plunges into the article cavity and bearers on the threadless shank of the projectile carrier so as to by way of the threadless shank of the projectile carrier form a branch of the tube to be molded as the article.

Alternatively, it can be provided that the second mold core engages in a depression in the smooth-walled shank of the projectile carrier so as to by way of the projectile carrier form a branch of the tube to be molded as the article.

According to the invention, further mold cores by way of which further outlets or branches of the tube are capable of being manufactured can be provided.

The invention furthermore relates to a method for manufacturing tubes having an undercut internal geometry, preferably having an internal thread, by injection molding a thermoplastic molding compound by means of an injection molding device having a tool having an article cavity which substantially defines the external contour of a tube to be manufactured as the article, while using an injection device which is configured to drive a projectile through the article cavity that is filled with a thermoplastic molding compound while displacing a liquid core of the molding compound, and while using a projectile carrier which as a mold core is provided with a part that stamps a contour or forms a thread, wherein the method comprises the following method steps:
a) equipping the projectile carrier with a projectile;
b) closing the tool around the projectile carrier, or introducing the projectile carrier into the closed tool such that the projectile carrier seals the article cavity;
c) at least partially filling the article cavity with a plasticized molding compound, wherein a tubular portion having an undercut geometry or an internal thread portion is formed in part of the article cavity;
d) directing a pressurized fluid into the article cavity by means of the injection device such that the fluid drives the projectile through the article cavity while displacing part of the molding compound in such a manner that the projectile forms a tubular article that is configured as a hollow body;
e) demolding the part of the projectile carrier that stamps the contour or forms the thread; and
f) opening the tool and retrieving the article.

The method steps a) to e) are preferably carried out in the order of the enumeration thereof. Steps e) and f) can be carried out simultaneously or in the reverse order. It is provided according to the invention that the projectile carrier during the filling of the plasticized molding compound plunges into the article cavity.

A stamping core which is configured as a rotary core and which is removed by way of a rotating movement is preferably used as the thread-forming part of the projectile carrier.

In the case of one advantageous variant of the method according to the invention it is provided that the internal thread portion is widened in the manner of a sleeve.

In the case of another advantageous variant of the method according to the invention it is provided that the tubular article is manufactured while using a second mold core having a tubular branch, wherein the second mold core in a first deployed position is brought to bear on a threadless shank of the projectile carrier. To this end, the second mold core can have a concave end face, for example, which is brought to bear in a sealing manner on a shell area of the smooth-walled shank of the projectile carrier.

Alternatively, a depression for receiving an end face of the second mold core can be provided in the shell area of the smooth-walled shank, the second mold core in the first deployed position engaging in said depression.

The second mold core after the method step b) is expediently moved to the deployed position and before the method step e) or simultaneously with the method step e) is demolded again, that is to say moved to a retracted position.

A filling tube of a fluid container for a motor vehicle, having a portion which is widened in the manner of a sleeve and provided with an internal thread, is expediently manufactured as the tubular article with the method according to the invention.

### BRIEF DESCRIPTION OF THE DRAWING

The invention will be explained hereunder with reference to the exemplary embodiment illustrated in the drawing in which:

FIG. 1 is a schematic partial view of an injection molding device.

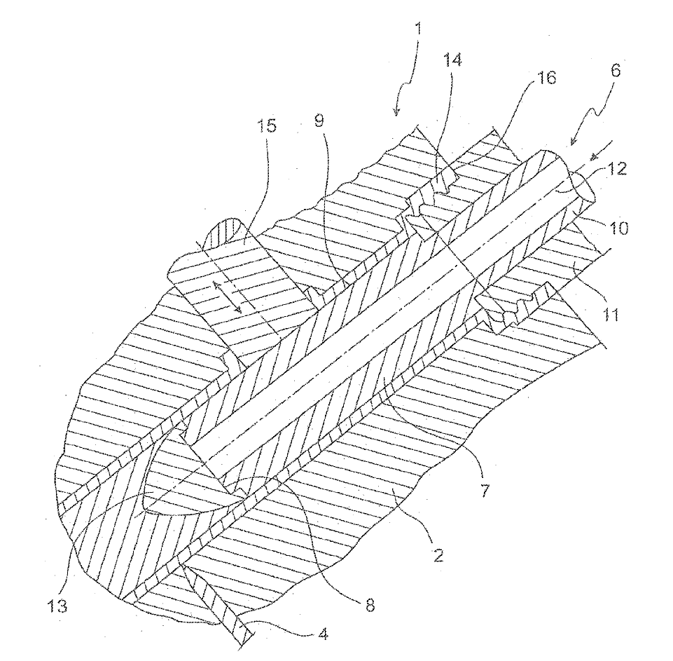

### DETAILED DESCRIPTION

For reasons of simplicity, one or a plurality of devices for extruding the thermoplastic molding compound are not illustrated. The injection molding device 1 comprises a tool which is composed of, for example, two mold halves which define an article cavity 3. The article cavity 3 can be configured, for example, as the negative of a tube (3D tube) that is curved multiple times in space. The tool can comprise a plurality of movable components in the form of slides or the like, and at least one secondary cavity. The secondary cavity is capable of being locked in relation to the article cavity 3 by means of slides. These details for reasons of simplicity are likewise not illustrated in the FIGURE.

The FIGURE shows an end of the article cavity 3 in the region of an end of the tube that is to be molded as the article, for example. The tool 2 comprises a sprue 4 which opens into the article cavity 3. An injection device 6 having a projectile carrier 7 is furthermore disposed on the tool 2. The projectile carrier 7 is configured as a multiple-part mold core. Said mold core comprises a projectile receptacle 8 which forms the leading end of the projectile carrier 7, a smooth-walled shank 9 that adjoins the projectile receptacle 8, and a receptacle 10 for a stamping core 11 which is configured as a rotary core. The stamping core 11 has a thread-forming, or thread-stamping, respectively, external contour. Said external contour can have one or a plurality of continuous or interrupted thread webs which produce an internal thread of the article to be fabricated, or of the tube to be fabricated, respectively, as will yet be explained later.

The projectile carrier 7 furthermore comprises a fluid duct 12 which extends from a base of the projectile carrier 7 to the projectile receptacle 8. A pressurized fluid, for example water, is capable of being driven by way of the fluid duct 12 through the projectile carrier 7 toward a projectile 13 that is plug fitted to the projectile receptacle 8. The projectile 13 is driven through the article cavity 3 by means of the pressure of the fluid that is supplied by way of the injection device 6. The projectile receptacle 8 is configured as a diameter step on the leading end of the projectile carrier 7. The projectile 13 has an internal diameter which corresponds to the diameter of the diameter step. The projectile 13 terminates so as to be flush with the external diameter of the smooth-walled shank 9. The external diameter of the smooth-walled shank 9 corresponds to the internal diameter of the tube to be fabricated. The annular space 14 that is formed between the smooth-walled shank 9 and the tool 2 is capable of being filled with the thermoplastic molding compound, as will yet be described hereunder, such that the tubular article in this region forms a calibrated tube end having an internal diameter that is predefined by the diameter of the smooth-walled shank 9.

A second mold core which is mounted in the tool 2 so as to be adjustable transversely relative to the longitudinal axis of the projectile carrier 7 is identified by the reference sign 15. In the position of the second mold core 15 shown in the FIGURE, said second mold core 15 bears tightly on the smooth-walled shank 9 of the projectile carrier 7. The tool 2 in this region is configured such that a port-type outlet, or a port-type branch, respectively, of the article to be molded can be configured by means of the second mold core 15. The end face of the second mold core 15 has a design embodiment that is complementary to the shell area of the smooth-walled shank 9.

In the method according to the invention, first the tool is closed around the projectile carrier 7 that is equipped with the projectile 13, for example. The second mold core 15 is brought to bear on the smooth-walled shank 9 of the projectile carrier 7.

As is illustrated also in the FIGURE, the mold core 11 is located in a thread-forming first position in which the stamping core 11 seals the article cavity 3. The stamping core 11 according to the exemplary embodiment has a diameter that is larger than the diameter of the smooth-walled shank 9. The article cavity 3 in the region in which the stamping core 11 projects into the article cavity 3 is likewise configured so as to have an enlarged diameter such that an end portion of the tube having a cross section that is widened in the manner of a sleeve is created in the region.

The article cavity 3 is then partially or completely filled by way of the sprue 4 with a molding compound of a thermoplastic plastics material. A tubular article having an internal thread portion is already created at this point of time in the region of the annular space 14.

After the article cavity 3 has been filled a pressurized fluid is injected through the projectile carrier 7. This fluid drives the projectile 13 through the article cavity 3. The projectile 13 herein displaces the molten core of the plasticized thermoplastic plastics material that has been filled into the article cavity 3.

The largest diameter of the projectile 13 corresponds to the external diameter of the smooth-walled shank 9 such that the projectile 13 generates a stationary tube wall, the wall thickness of the latter corresponding to the wall thickness of the tube wall in the region of the annular space 14.

The stamping core 11 has an encircling sealing shoulder 16 by way of which said stamping core 11 seals the article cavity 3, or the annular space 14, respectively. The sealing shoulder generates a smooth-walled sealing face of the article or tube, respectively, to be fabricated.

Once the projectile 13 has been driven through the article cavity 3, the second mold core 15 is moved to a retracted position; the stamping core 11 is thereafter moved from the thread-forming first position shown in the FIGURE to a second position in which said stamping core 11 releases the article cavity 3 or the annular space 14, respectively. This position is not shown in the FIGURE.

The article thereafter can be retrieved from the tool 2.

### LIST OF REFERENCE SIGNS

1 Injection molding device
2 Tool
3 Article cavity
4 Sprue
5 Not allocated
6 Injection device
7 Projectile carrier
8 Projectile receptacle
9 Smooth-walled shank
10 Receptacle for the stamping core
11 Stamping core
12 Fluid duct
13 Projectile
14 Annular space
15 Second mold core
16 Sealing shoulder

What is claimed is:

1-13. (canceled)

14. An injection molding device for manufacturing tubes having an internal thread, having a tool that forms an article cavity, having means for filling the article cavity with a thermoplastic molding compound, having an injection device for injecting a fluid toward a projectile to be driven through the article cavity, wherein the injection device comprises a projectile carrier having at least one injection nozzle and having at least one projectile receptacle for a projectile as a displacement member for the molding compound, wherein the projectile carrier at an end that is remote from the projectile receptacle is provided with a thread-bearing stamping core which is adjustable relative to the projectile carrier between a first position that forms a thread, and a demolded second position, wherein the stamping core in the first position plunges into the article cavity and seals the latter,
wherein
the stamping core is configured as a rotary core.

15. The injection molding device as claimed in claim 14, wherein the projectile carrier is configured as a multiple-part first mold core having a smooth-walled shank and having a receptacle for the stamping core.

16. The injection molding device as claimed in claim 14, wherein the smooth-walled shank of the projectile carrier has an external diameter which approximately corresponds to the internal diameter of the tube to be molded as the article.

17. The injection molding device as claimed in claim 14, wherein the receptacle for the stamping core is configured as a guide spindle for the stamping core, the former having a spindle drive that is complementary thereto.

18. The injection molding device as claimed in claim 14, comprising at least one second mold core which in a first position plunges into the article cavity and bears on the smooth-walled shank of the projectile carrier so as to by way of the smooth-walled shank of the projectile carrier form a branch of the tube to be molded as the article.

19. The injection molding device as claimed in claim 14, wherein a second mold core in a first position plunges into the article cavity and engages in a depression in the smooth-walled shank of the projectile carrier so as to by way of the projectile carrier form a branch of the tube to be molded as the article.

20. A method for manufacturing tubes having an internal thread, by injection molding a thermoplastic molding compound by means of an injection molding device having a tool having an article cavity which substantially defines the external contour of a tube to be manufactured as the article, while using an injection device which is configured to drive a projectile through the article cavity that is filled with a thermoplastic molding compound while displacing a liquid core of the molding compound, and while using a projectile carrier which as a mold core is provided with a part that forms a thread, wherein the method comprises the following method steps:
a) equipping the projectile carrier with a projectile;
b) closing the tool around the projectile carrier, or introducing the projectile carrier into the closed tool such that the projectile carrier seals the article cavity;
c) at least partially filling the article cavity with a plasticized molding compound, wherein an internal thread portion is formed in part of the article cavity;
d) directing a pressurized fluid into the article cavity by means of the injection device such that the fluid drives the projectile through the article cavity while displacing part of the molding compound in such a manner that the projectile forms a tubular article that is configured as a hollow body;
e) demolding the part of the projectile carrier that forms the contour the thread; and
f) opening the tool and retrieving the article,
wherein
a stamping core which is removed by way of a rotating movement is used as the thread-forming part of the projectile carrier, and in that the stamping core in step e) is adjusted relative to the projectile carrier between a thread-forming first position and a demolded second position.

21. The method as claimed in claim 20, wherein the internal thread portion is widened in the manner of a sleeve.

22. The method as claimed in claim 20, wherein the tubular article is manufactured while using a second mold core having a tubular branch, wherein the second mold core in a first deployed position is brought to bear on a smooth-walled shank of the projectile carrier or engages in a depression in the smooth-walled shank of the projectile carrier.

23. The method as claimed in claim 22, wherein the second mold core after method step b) and before method step c) is moved to the first deployed position and is retracted before method step f).

24. The method as claimed in claim 20, wherein a filling tube of a fluid container for a motor vehicle, having a portion which is widened in the manner of a sleeve and provided with an internal thread, is manufactured as the tubular article.
